(19) United States
(12) Patent Application Publication
(10) Pub. No.: US 2009/0079985 A1
(43) Pub. Date: Mar. 26, 2009

(54) STIRRING STATE DETECTING METHOD

(75) Inventors: Jin MURAOKA, Osaka (JP); Tatsurou Kawamura, Kyoto (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/323,108

(22) Filed: Nov. 25, 2008

Related U.S. Application Data
(63) Continuation-in-part of application No. PCT/JP2008/001052, filed on Apr. 22, 2008.

(30) Foreign Application Priority Data
May 15, 2007 (JP) 2007-128917

(51) Int. Cl. G01N 21/59

(52) U.S. Cl. 356/440

(57) ABSTRACT

A stirring state detecting method of the present invention is a method for detecting a stirring state of a test solution by using: a sample cell (101) which holds the test solution in an internal space thereof; a stirring device (111) which stirs the test solution held in the sample cell (101); a light emitting device (106) which emits light to the test solution held in the sample cell (101); and a photoreceiver (108) which receives the light, and includes the steps of: (A) in a state in which the test solution is held in the sample cell (100), activating the stirring device (111) to change a liquid level (102) of the test solution by stirring; (B) emitting the light from the light emitting device (106) to the test solution held in the sample cell (100); (C) detecting by the photoreceiver (108) an amount of the light which is emitted to the test solution and subjected to an action of the test solution whose liquid level (102) is changed by the stirring; and (D) determining the stirring state of the test solution based on the amount of the light detected by the photoreceiver (108) in the step (C).

### TECHNICAL FIELD

The present invention relates to a stirring state detecting method used when mixing, by stirring, a sample solution and a reagent held in a container.

### BACKGROUND ART

Generally, it is desirable that when measuring an optical property of a test solution containing a sample solution and a reagent, the sample solution and the reagent be uniformly mixed in the test solution. Therefore, the test solution containing the sample solution and the reagent held in the container is stirred before measuring the optical property.

Proposed as a method for stirring the test solution held in the container is, for example, a method using a rotor which incorporates a magnetic body. For example, in accordance with a method disclosed in Patent Document 1, the container including the rotor is mounted on a driving unit including an electric motor in which a magnet is attached to a rotating shaft, and the rotor is rotated by rotation of the electric motor of the driving unit, thereby stirring the test solution held in the container.

However, in the case of using the method using the rotor which incorporates the magnetic body, the test solution may not be stirred adequately since the rotation of the rotor may not synchronize with the rotation of the magnet of the driving unit.

Here, Patent Document 1 discloses a method for detecting the number of rotations of the rotor itself by detecting using a magnetic sensor a magnetic field generated by the rotation of the rotor.

Patent Document 1: Japanese Laid-Open Utility Model Application Publication

### DISCLOSURE OF THE INVENTION

### Problems to be Solved by the Invention

However, since the magnetic sensor is used to detect a rotation state of the rotor itself in the method of Patent Document 1, erroneous measurement may occur when the magnetic field around the device has changed.

The present invention was made in light of the problems of the above prior art, and an object of the present invention is to provide a stirring state detecting method capable of accurately detecting a stirring state of the test solution held in the container without being affected by ambient surroundings.

### Means for Solving the Problems

In order to solve the problems of the above prior art, a stirring state detecting method according to the present invention is a method for detecting a stirring state of a test solution by using: a sample cell which holds the test solution in an internal space thereof; a stirring device which stirs the test solution held in the sample cell; a light emitting device which emits light to the test solution held in the sample cell; and a photoreceiver which receives the light, the method comprising the steps of: (A) in a state in which the test solution is held in the sample cell, activating the stirring device to change a liquid level of the test solution by stirring; (B) emitting the light from the light emitting device to the test solution held in the sample cell; (C) detecting by the photoreceiver an amount of the light which is emitted to the test solution and subjected to an action of the test solution whose liquid level is changed by the stirring; and (D) determining the stirring state of the test solution based on the amount of the light detected by the photoreceiver in the step (C).

The above object, other objects, features and advantages of the present invention will be made clear by the following detailed explanation of preferred embodiments with reference to the attached drawings.

### EFFECTS OF THE INVENTION

In accordance with the stirring state detecting method of the present invention, the stirring state of the test solution held in the container can be accurately detected without being affected by the ambient surroundings.

### BRIEF DESCRIPTION OF THE DRAWINGS

FIG. 1 is a schematic diagram showing a schematic configuration of an optical measuring device used in a stirring state detecting method according to Embodiment 1 of the present invention.

FIG. 2 is a schematic diagram showing a state in which a magnetic rotor disposed inside a sample cell of the optical measuring device shown in FIG. 1 is rotated.

FIG. 3 is a schematic diagram showing a time change of an output signal S from an optical sensor of the optical measuring device shown in FIG. 1.

FIG. 4 is a schematic diagram showing the time change of the output signal S from the optical sensor of the optical measuring device shown in FIG. 1.

FIG. 5 is a schematic diagram showing the time change of the output signal S from the optical sensor of the optical measuring device shown in FIG. 1.

FIG. 6(A) is a flow chart schematically showing a content of a stirring detecting program stored in a memory of the optical measuring device shown in FIG. 1.

FIG. 6(B) is a flow chart schematically showing the content of the stirring detecting program stored in the memory of the optical measuring device shown in FIG. 1.

FIG. 7 is a top view showing a schematic configuration of the optical measuring device used in the stirring state detecting method according to Embodiment 2.

FIG. 8 is a schematic diagram showing a partial schematic configuration in a state in which the test solution is supplied in the sample cell of the optical measuring device shown in FIG. 7.

FIG. 9 is a schematic diagram showing a partial schematic configuration in a state in which the magnetic rotor disposed inside the sample cell of the optical measuring device shown in FIG. 7 is rotated.

FIG. 10 is a schematic diagram showing the time change of the output signal S from the optical sensor of the optical measuring device shown in FIG. 7.

FIG. 11 is a top view showing a schematic configuration of the optical measuring device used in the stirring state detecting method according to Embodiment 3.

FIG. 12 is a schematic diagram showing a partial schematic configuration in a state in which the test solution is supplied in the sample cell of the optical measuring device shown in FIG. 11.

FIG. 13 is a schematic diagram showing a partial schematic configuration in a state in which the magnetic rotor disposed inside the sample cell of the optical measuring device shown in FIG. 11 is rotated.

FIG. 14 is a schematic diagram showing the time change of the output signal S from the optical sensor of the optical measuring device shown in FIG. 11.

FIG. 15 is a schematic diagram showing a schematic configuration of the optical measuring device used in the stirring state detecting method according to Embodiment 4 of the present invention.

FIG. 16 is a schematic diagram of the sample cell of the optical measuring device when viewed from a direction indicated by an arrow A shown in FIG. 15.

FIG. 17 is a schematic diagram showing a schematic configuration in a state in which the rotor disposed inside the sample cell of the optical measuring device shown in FIG. 16 is rotated.

FIG. 18 is a schematic diagram showing a schematic configuration of the optical measuring device used in the stirring state detecting method according to Embodiment 5 of the present invention.

FIG. 19 is a schematic diagram showing a schematic configuration in a state in which the sample cell of the optical measuring device shown in FIG. 18 is rotated or turned.

### EXPLANATION OF REFERENCE NUMBERS

100 optical measuring device
101 sample cell
102 liquid level
103 magnetic rotor
104 magnetic rotor driving unit
105 display device
106 semiconductor laser module
107 laser light
108 optical sensor
109 computer
110 opening
112 input device
200 rotating shaft
202 magnet
204 optical window
206 optical window
810 beam splitter

### BEST MODE FOR CARRYING OUT THE INVENTION

A stirring state detecting method according to the present invention is a method for detecting a stirring state of a test solution by using: a sample cell which holds the test solution in an internal space thereof; a stirring device which stirs the test solution held in the sample cell; a light emitting device which emits light to the test solution held in the sample cell; and a photoreceiver which receives the light, and the stirring state detecting method includes the steps of: (A) in a state in which the test solution is held in the sample cell, activating the stirring device to change a liquid level of the test solution by stirring; (B) emitting the light from the light emitting device to the test solution held in the sample cell; (C) detecting by the photoreceiver an amount of the light which is emitted to the test solution and subjected to an action of the test solution whose liquid level is changed by the stirring; and (D) determining the stirring state of the test solution based on the amount of the light detected by the photoreceiver in the step (C).

With this, when the stirring device is normally activated to stir the test solution, the liquid level of the test solution in the sample cell is depressed in a bowl shape. Therefore, when the light is emitted from the light emitting device to the sample cell so as to travel across the bowl-shape depressed liquid level of the test solution, the light emitted from the light emitting device is reflected and refracted at the bowl-shape depressed liquid level of the test solution. Thus, the amount of the light traveling in a predetermined direction changes. Therefore, by detecting using the photoreceiver the amount of the light traveling in the predetermined direction and subjected to the action of the test solution, it is possible to determine the stirring state by the change of the amount of the light detected. Since a magnetic sensor is not used for this determination, the stirring state of the test solution is accurately determined without being affected by ambient surroundings.

Examples of the light emitting device are a semiconductor laser and a helium neon laser. Moreover, one example of the photoreceiver is a photodiode. Further, the reagent may be added to the sample solution in the sample cell after the sample solution is supplied in the sample cell. In contrast, the sample solution may be supplied in the sample cell after the reagent is supplied in the sample cell. Moreover, the reagent may be held in the sample cell in advance.

Moreover, in the stirring state detecting method according to the present invention, the stirring device may include a magnetic rotor having a magnetic body, and a magnetic rotor driving unit which generates a change in a magnetic field which causes the magnetic rotor to rotate.

Examples of the magnetic body included in the magnetic rotor are a neodymium magnet, a samarium-cobalt magnet, a ferrite magnet, an iron-platinum magnet, an iron-chromium-cobalt magnet, and an alnico magnet.

Moreover, in the stirring state detecting method according to the present invention, the stirring device may include a rotor, a rotating shaft connected to the rotor, and a rotating shaft driving unit which causes the rotating shaft to rotate.

Moreover, in the stirring state detecting method according to the present invention, the stirring device may include a drive mechanism which causes the sample cell to rotate or turn.

Moreover, in the stirring state detecting method according to the present invention, it is preferable that: the step (B) be carried out before activating the stirring device; and a step (E) of detecting by the photoreceiver the amount of the light subjected to the action of the test solution and determining based on the detected light whether or not the sample cell is filled with the test solution be then carried out.

Moreover, in the stirring state detecting method according to the present invention, when the amount of the light detected by the photoreceiver in the step (C) reaches a predetermined threshold in the step (D), it is determined that the test solution is not stirred.

In a case where the light detected by the photoreceiver is the light having been transmitted through the test solution and the light having been scattered laterally in the test solution, when the light is emitted from the light emitting device to the sample cell so as to travel across the bowl-shape depressed liquid level of the test solution, the light emitted from the light emitting device is reflected and refracted at the bowl-shape depressed liquid level of the test solution. Therefore, the amount of the light decreases. On this account, it is possible to determine that the test solution is stirred when the amount of the light detected by the photoreceiver is smaller than a predetermined threshold, and to determine that the test solution is not stirred when the amount of the light detected by the photoreceiver is larger than a predetermined threshold.

Meanwhile, the amount of the light detected by the photoreceiver increases in a case where the photoreceiver detects the light having been scattered rearward in the test solution. On this account, it is possible to determine that the test solution is stirred when the amount of the light detected by the photoreceiver is larger than a predetermined threshold, and to determine that the test solution is not stirred when the amount of the light detected by the photoreceiver is smaller than a predetermined threshold.

Moreover, it is preferable that the stirring state detecting method according to the present invention further include a step (F) of outputting an alarm by an alarm unit when it is determined that the test solution is not stirred. Examples of the alarm unit are a display which displays a message, a speaker which outputs a sound, a buzzer which outputs an alarm sound, and a light source which emits light indicating an alarm.

Moreover, it is preferable that the stirring state detecting method according to the present invention further include a step (G) of causing the stirring device to stop operating when it is determined that the test solution is not stirred.

Moreover, the stirring state detecting method according to the present invention may further include a step (H) of activating the stirring device again after causing the stirring device to stop operating in the step (G).

Further, the stirring state detecting method according to the present invention may further include a step (I) of finding an optical property of the test solution based on the amount of the light detected by the photoreceiver after the stirring state of the test solution is determined in the step (D).

With this, the device configuration is simplified since the optical property of the test solution is measured using the light emitting device and the photoreceiver also used to detect the stirring state.

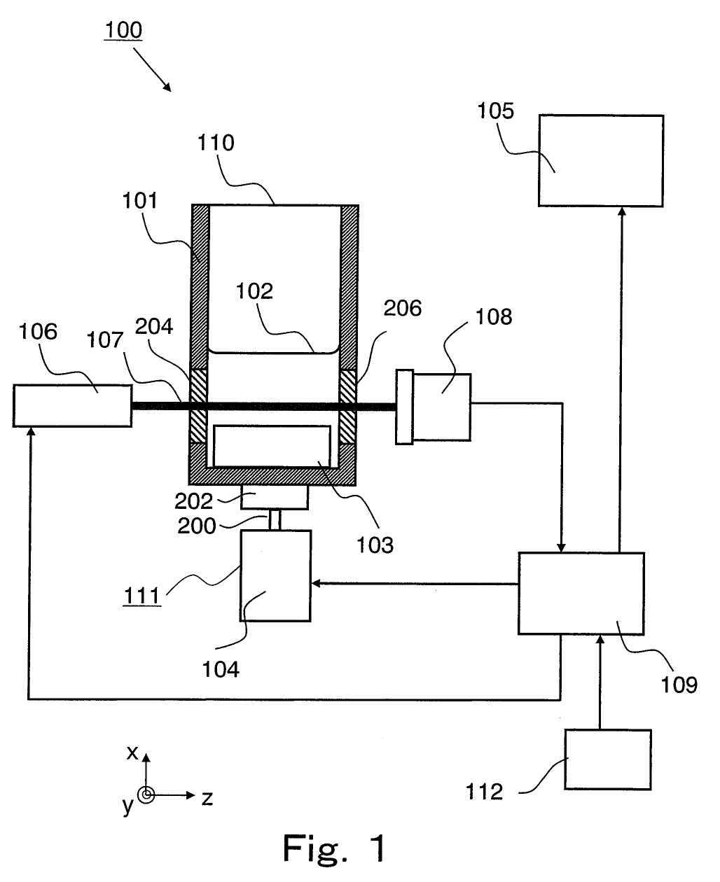

Hereinafter, the best mode for carrying out the present invention will be explained in detail in reference to the drawings. In the drawings, same reference numbers are used for the same or corresponding members, and same explanations may be omitted. In FIGS. 1, 2, 7 to 9, 11 to 13, and 15 to 18, for convenience sake, directions in the configuration of the optical measuring device are indicated by an X-axis, a Y-axis, and a Z-axis of a 3-D rectangular coordinate system.

### EMBODIMENT 1

The stirring state detecting method according to Embodiment 1 of the present invention will be explained in reference to FIG. 1. FIG. 1 is a schematic diagram showing a schematic configuration of the optical measuring device used in the stirring state detecting method according to Embodiment 1 of the present invention.

As shown in FIG. 1, an optical measuring device 100 includes: a sample cell 101 which holds the test solution and in which a magnetic rotor 103 having a magnetic body is disposed; a magnetic rotor driving unit 104 which has a magnet 202 attached to a rotating shaft 200, and generates the change in the magnetic field which causes the magnetic rotor 103 to rotate; a semiconductor laser module 106 that is a light emitting device which emits light to the sample cell 101; an optical sensor 108 which receives transmitted light which has been transmitted through the sample cell 101 and emitted from the sample cell 101; a computer 109 constituted by a control unit which controls the magnetic rotor driving unit 104 and the semiconductor laser module 106, and a determining unit which determines based on an output from the optical sensor 108 whether or not the magnetic rotor 103 is normally rotated; a display device 105 which displays a result of the determination; and an input device 112 to which an instruction to the computer 109 is input. Here, the semiconductor laser module 106 corresponds to the light emitting device of the present invention, and the optical sensor 108 corresponds to the photoreceiver of the present invention. Moreover, the magnetic rotor 103 and the magnetic rotor driving unit 104 constitute a stirring device 111.

The sample cell 101 is a rectangular-solid acryl-made container having an opening 110 on one surface thereof. During use, the sample cell 101 is placed such that the opening 110 faces upward in a vertical direction. Two optical windows 204 and 206 whose surfaces are mirror finished are disposed on two opposing side surfaces, respectively, of side surfaces surrounding the sample cell 101. In the present embodiment, the sample cell 101 has a bottom surface of a 5 mm square and a height of 20 mm. Therefore, a distance between the optical windows 204 and 206 is 5 mm.

The magnetic rotor 103 is columnar, and herein has a circular bottom surface of 3 mm in diameter and a height of 2.9 mm. As shown in FIG. 1, the magnetic rotor 103 is disposed inside the sample cell 101 such that the longitudinal direction of the column is oriented horizontally.

For example, a neodymium magnet is used as the magnetic body included in the magnetic rotor 103 and the magnet 202 included in the magnetic rotor driving unit 104. Instead of the neodymium magnet, a samarium-cobalt magnet, a ferrite magnet, an iron-platinum magnet, an iron-chromium-cobalt magnet, an alnico magnet, or the like may be used.

The semiconductor laser module 106 projects circular laser light 107 having a wavelength of 670 nm, an intensity of 3.0 mW, a beam radius of 0.5 mm with respect to the optical window 204 of the sample cell 101 in a direction (z direction in FIG. 1) perpendicular to the optical window 204. The semiconductor laser module 106 is disposed such that the laser light 107 travels inside the sample cell 101 in a direction parallel to the bottom surface of the sample cell 101, and an optical axis of the laser light 107 is located 4 mm away from the bottom surface of the sample cell 101.

The optical sensor 108 receives the transmitted light which has been transmitted through the sample cell 101 to be emitted from the optical window 206, and outputs an output signal S corresponding to the amount of the light received. The computer 109 includes a calculating section, a timer section, and a memory (all of which are not shown). The calculating section analyzes the output signal S from the optical sensor 108 to determine whether or not the magnetic rotor 103 is normally rotated. In a case where it is determined that the magnetic rotor 103 is not normally rotated as a result of the analysis, the computer 109 causes the display device 105 to display error information (alarm). Here, the display device 105 corresponds to the alarm unit of the present invention.

Moreover, the optical measuring device 100 used in the stirring state detecting method according to Embodiment 1 of the present invention is configured such that: after it is determined that the magnetic rotor 103 is normally rotated, the semiconductor laser module 106 again emits the laser light 107 to the optical window 204 of the sample cell 106; the optical sensor 108 receives the laser light 107 which has been transmitted through the sample cell 106 to be emitted from the optical window 206; and thereby an optical activity of the test solution can be measured.

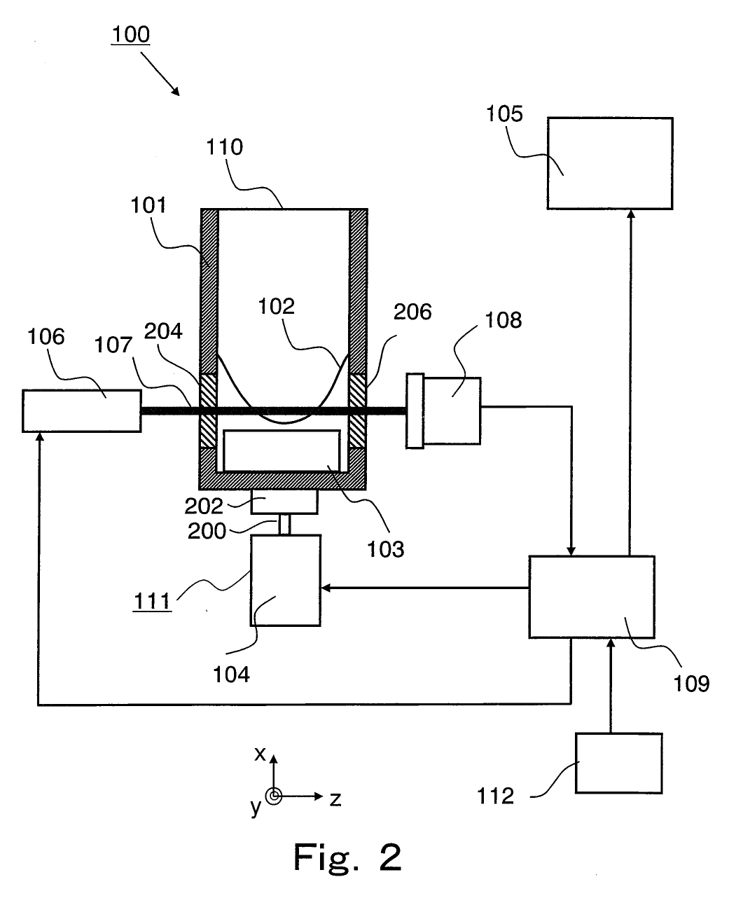

Next, a method for analyzing the output signal S from the optical sensor 108 using the optical measuring device 100 shown in FIG. 1 to determine whether or not the magnetic rotor 103 is normally rotated will be explained in reference to FIGS. 1 and 2. FIG. 2 is a schematic diagram showing a state in which the magnetic rotor 103 disposed inside the sample cell 101 of the optical measuring device 100 shown in FIG. 1 is rotated.

The laser light 107 emitted from the semiconductor laser module 106 of the optical measuring device 100 shown in FIGS. 1 and 2 has a circular cross section. Since the laser light 107 is a Gaussian beam, a light power density of the laser light 107 is the highest on the optical axis in a cross section (hereinafter abbreviated as a beam cross section) perpendicular to the traveling direction z. The power density of the laser light 107 at a position in the beam cross section of the laser light 107 decreases in accordance with Formula (1) below as the position is farther away from the optical axis.

$$I ( r ) = I ( 0 ) \times exp ( - \frac{2 {r}^{2}}{{w}_{o}^{2}} ) \qquad Formula ( 1 )$$

In Formula (1), r denotes a distance (m) from the optical axis in the beam cross section, I(r) denotes the power density (W/m²) at a position away from the optical axis by the distance r, I(0) denotes the power density (W/m²) on the optical axis, and w₀ denotes the beam radius. The beam radius w₀ is defined as a distance (m) when the power density is 1/e² of I(0). This “e” denotes a natural logarithm.

The power of the laser light 107 in a circle centered about the optical axis and having the radius r in the beam cross section can be obtained by integrating the power density I(r). It can be seen from Formula (1) that the light power of about 86.5% of the total power of the laser light 107 exists in a circle centered about the optical axis and having the beam radius w₀ in the beam cross section. Similarly, it can be seen from Formula (1) that the light power of about 99.97% of the total power of the laser light 107 exists in a circle centered about the optical axis and having a radius 2w₀ in the beam cross section. Here, the beam radius of the laser light 107 actually expands by a diffraction effect as the laser light 107 travels. However, the laser light 107 can be substantially regarded as parallel light in the case of the size explained in the present invention.

Therefore, for example, as shown in FIG. 1, the test solution containing the sample solution and the reagent is supplied in the sample cell 101 such that a distance from the optical axis of the laser light 107 to a lowermost portion of a liquid level 102 of the test solution becomes four times as long as the beam radius, i.e., a distance d from the lowermost portion of the liquid level 102 to the bottom surface of the sample cell 101 becomes 6 mm. At this time, the laser light 107 corresponding to the light power of about 99.97% of the total power travels in the test solution.

Next, when the magnetic rotor driving unit 104 is driven to cause the magnetic rotor 103 to rotate, the liquid level 102 of the test solution is depressed in a bowl shape, and the position of the lowermost portion of the liquid level 102 lowers. As shown in FIG. 2, the magnetic rotor 103 is rotated such that the lowermost portion of the liquid level 102 of the test solution is lower than a position which is lower than the optical axis of the laser light 107 by a distance of the beam radius, i.e., the distance d is shorter than 3.5 mm. At this time, the laser light 107 corresponding to the light power of more than about 86.5% of the total power travels across the liquid level 102 of the test solution. When the laser light 107 travels across the liquid level 102 of the test solution, the laser light 107 is reflected and refracted at the liquid level 102. Therefore, a light path of the laser light 107 changes. On this account, the amount of the light which reaches the optical sensor 108 decreases. Thus, the output signal S from the optical sensor 108 decreases.

When the magnetic rotor 103 cannot follow a rotational movement of the magnet 202, which is attached to the rotating shaft 200 of the magnetic rotor driving unit 104, while the magnetic rotor driving unit 104 is driving, and the magnetic rotor 103 is rotating, the magnetic rotor 103 stops rotating. When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. With this, the output signal S from the optical sensor 108 increases.

Therefore, by detecting that the output signal S from the optical sensor 108 has been once decreased by the rotation of the magnetic rotor 103 in conjunction with the start of the operation of the magnetic rotor driving unit 104 and again increased, it is possible to detect that the magnetic rotor 103 has stopped rotating.

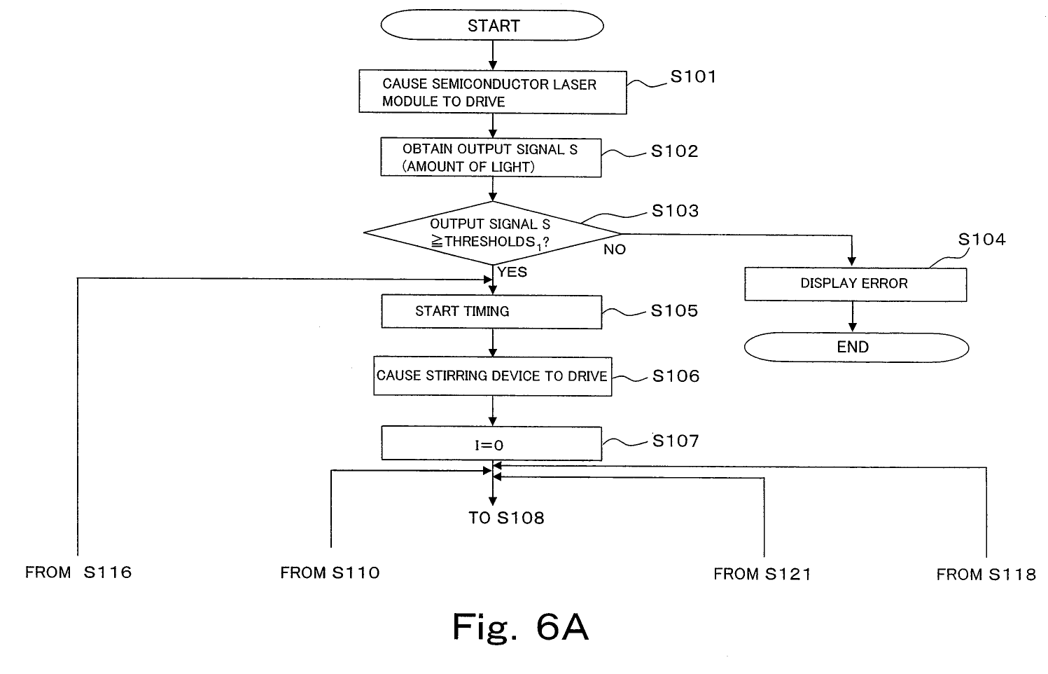

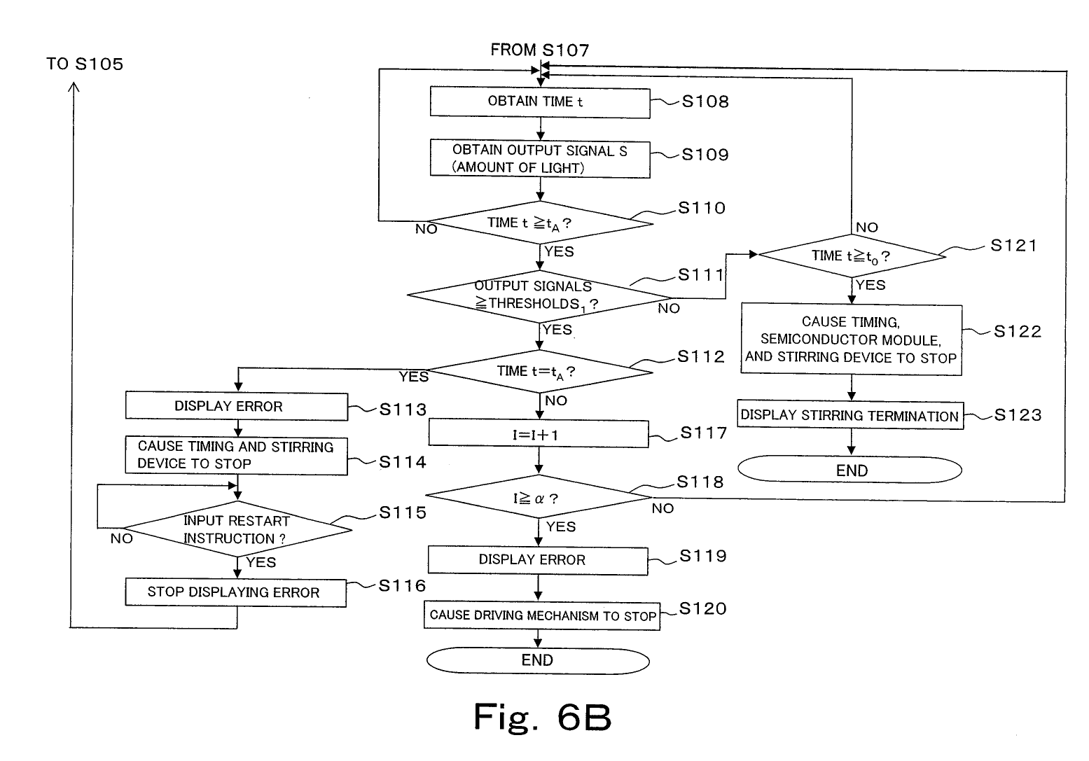

Next, a series of steps of the stirring state detecting method of Embodiment 1 will be explained in reference to the flow charts shown in FIG. 6.

FIGS. 6(A) and 6(B) are flow charts schematically showing the content of a stirring detecting program stored in the memory of the optical measuring device 100 shown in FIG. 1.

First, the computer 109 which has received a stirring start instruction from the input device 112 causes the semiconductor laser module 106 to drive (Step S101). Thus, the semiconductor laser module 106 projects the laser light 107 toward the optical window 204 of the sample cell 101. Next, the computer 109 obtains from the optical sensor 108 the output signal S corresponding to the amount of the light received, thereby starting measuring the transmitted light which has been transmitted through the sample cell 101 to be emitted from the optical window 206 (Step S102).

Next, the computer 109 determines whether or not the output signal S obtained in Step S102 is a predetermined threshold S₁ or more (Step S103). When the output signal S obtained in Step S102 is less than the threshold S₁, the computer 109 determines that a specified amount of test solution is not filled up, and causes the display device 105 to display the error information (Step S104). Then, the computer 109 terminates this program.

On the other hand, when the output signal S obtained in Step S102 is the threshold S₁ or more, the computer 109 determines that the specified amount of test solution is filled up, and causes the timer section, not shown, to start timing (Step S105) and causes the stirring device 111 to drive (Step S106). Thus, the timer section starts timing, and the stirring device 111 drives to start stirring the test solution.

Next, the computer 109 sets I to 0 (Step S107), and obtains a time t from the timer section (Step S108). Next, the computer 109 obtains from the optical sensor 108 the output signal S corresponding to the amount of the light received (Step S109). Then, the computer 109 determines whether or not the time t obtained in Step S108 is a predetermined time t_{A} (Step S110). The computer 109 repeats Step S108 to Step S110 until the predetermined time t_{A} passes. When the predetermined time t_{A} passes, the process proceeds to Step S111.

In Step S111, whether or not the output signal S obtained in Step S109 is the predetermined threshold S₁ or more is determined. When the output signal S obtained in Step S102 is less than the predetermined threshold S₁, the process proceeds to Step S121. When the output signal S obtained in Step S102 is the predetermined threshold S₁ or more, the process proceeds to Step S112. Step S121 and the following steps will be described later.

In Step S112, the computer 109 determines whether or not the time t obtained in Step S108 is the predetermined time t_{A}. In a case where the time t obtained in Step S108 is the predetermined time t_{A}, it is determined that in a period from the start of the stirring operation until the predetermined time t_{A}, the magnetic rotor 103 cannot follow the rotational movement of the magnet 202 and is not carrying out the rotational movement, i.e., the magnetic rotor 103 is not stirring the test solution. Therefore, the computer 109 causes the display device 105 to display the error information (Step S113). Next, the computer 109 causes the timer section to stop timing, and causes the drive mechanism 111 to stop driving (Step S114). Thus, the timer section stops timing, and the drive mechanism 111 causes the magnet 202 to stop rotating. Next, the computer 109 determines whether or not a restart instruction has been input from the input device 112 (Step S115). The computer 109 repeats Step S115 until the restart instruction is input. When the restart instruction is input, the process proceeds to Step S116. In Step S116, the computer 109 causes the display device 105 to stop displaying the error information.

On the other hand, when the time t obtained in Step S108 is not the predetermined time t_{A} in Step S112, i.e., when the time t obtained in Step S108 exceeds the predetermined time t_{A} in Step S112, the computer 109 sets I to I+1 (herein, I is 1) (Step S117), and the process proceeds to Step S118. In Step S118, the computer 109 determines whether or not I set in Step S117 is a predetermined number of times α (α is an integer of 2 or more).

When I set in Step S117 is less than the predetermined number of times α, the process returns to Step S108. With this, as will be described later, it is possible to configure the setting such that it is not determined that the test solution is not stirred when the output signal S from the optical sensor 108 is temporarily the threshold S₁ or more. Meanwhile, when I set in Step S117 is the predetermined number of times α or more, the process proceeds to Step S119. Note that the predetermined number of times α is determined by a detection interval of the transmitted light of the optical sensor 106 and a certain time (for example, 0.5 second or more) for which the output signal S continues to be the threshold S₁ or more.

In Step S119, the computer 109 causes the display device 105 to display the error information. Next, the computer 109 causes the drive mechanism 111 to stop driving (Step S120), and terminates the program.

Moreover, when the output signal S obtained in Step S102 is less than the predetermined threshold S₁ in Step S111, the computer 109 determines whether or not the time t obtained in Step S108 is a predetermined time t₀ or more. When the time t obtained in Step S108 is less than the time t₀, the process returns to Step S108, and Step S108 to Step S121 are repeated until the time t reaches the time t₀ or more. Meanwhile, when the time t obtained in Step S108 is the predetermined time t₀ or more, it is possible to determine that the stirring of the test solution is terminated, and the process proceeds to Step S122.

In Step S122, the computer 109 causes the timer section to stop timing, causes the stirring device 111 to stop driving, and causes the semiconductor laser module 106 to stop driving. Then, the computer 109 causes the display device 105 to display stirring termination information (Step S123), and terminates the program.

In the program, the stirring device 111 can restart many times when the magnetic rotor 103 is not rotated in a period from the start of driving of the stirring device 111 until the predetermined time t_{A}. However, the present embodiment is not limited to this. The number of times of the restart for the rotation of the magnetic rotor 103 may be limited. Moreover, the program terminates when the output signal S is the threshold S₁ or more after the predetermined time t_{A} passes. However, the present embodiment is not limited to this. The drive mechanism 111 may be additionally driven depending on the value of the time t at which the output signal S reaches the threshold S₁ or more.

Moreover, after the stirring termination information is displayed in Step S123, the output signal S corresponding to the amount of the light received may be obtained again from the optical sensor 108 to measure the optical activity of the test solution.

Next, a specific operation of the optical measuring device used in the stirring state detecting method according to Embodiment 1 of the present invention will be explained in reference to FIGS. 1 and 2.

First, a user supplies the sample solution in the sample cell 101 through the opening 110 formed at an upper portion of the sample cell 101. Next, the user supplies the reagent in the sample cell 101 through the opening 110. Thus, the test solution containing the sample solution and the reagent is prepared in the sample cell 101. At this time, the user supplies the sample solution and the reagent in the sample cell 101 such that the distance d from the lowermost portion of the liquid level 102 of the test solution to the bottom surface of the sample cell 101 becomes 6 mm. One example of a method for supplying a predetermined amount of sample solution is a method for obtaining using a syringe a predetermined amount of sample solution stored in a separate container and discharging the sample solution of the syringe through the opening 110 of the sample cell 101.

Next, the user inputs the stirring start instruction from the input device 112. When the computer 109 receives the stirring start instruction from the input device 112, the computer 109 causes the semiconductor laser module 106 to drive. In response to a signal from the computer 109, the semiconductor laser module 106 projects the laser light 107 to the optical window 204 of the sample cell 101. The computer 109 causes the semiconductor laser module 106 to drive, and at the same time, the computer 109 receives from the optical sensor 108 the output signal corresponding to the amount of the light received, thereby starting measuring the transmitted light which has been transmitted through the sample cell 101 to be emitted from the optical window 206.

Moreover, the computer 109 causes the semiconductor laser module 106 to drive, and at the same time, the computer 109 causes the driving unit 104 to drive. In response to the signal from the computer 109, the magnet 202 attached to the rotating shaft 200 of the driving unit 104 is rotated. The magnetic rotor 103 disposed inside the sample cell 101 starts the rotational movement in sync with the rotation of the magnet 202 of the driving unit 104. The driving unit 104 is controlled by the computer 109 so as to continue to drive for a predetermined time (t₀) in which the stirring of the test solution completes.

When the magnetic rotor 103 starts the rotational movement to stir the test solution held in the sample cell 101, the liquid level 102 of the test solution is depressed in a bowl shape, and thereby the position of the lowermost portion of the liquid level 102 lowers. At this time, the number of rotations of the magnet 202 is controlled such that the lowermost portion of the liquid level 102 of the test solution is lower than a position which is lower than the optical axis of the laser light 107 by a distance of the beam radius, i.e., the distance d is shorter than 3.5 mm. For example, when the test solution is urine, the number of rotations of the magnet 202 may be set to about 1,400 rotations per minute. In order that the magnetic rotor 103 disposed inside the sample cell 101 stably starts the rotational movement, the computer 109 gradually increases the number of rotations of the magnet 202 such that the number of rotations reaches a specified number of rotations in 3 seconds for example.

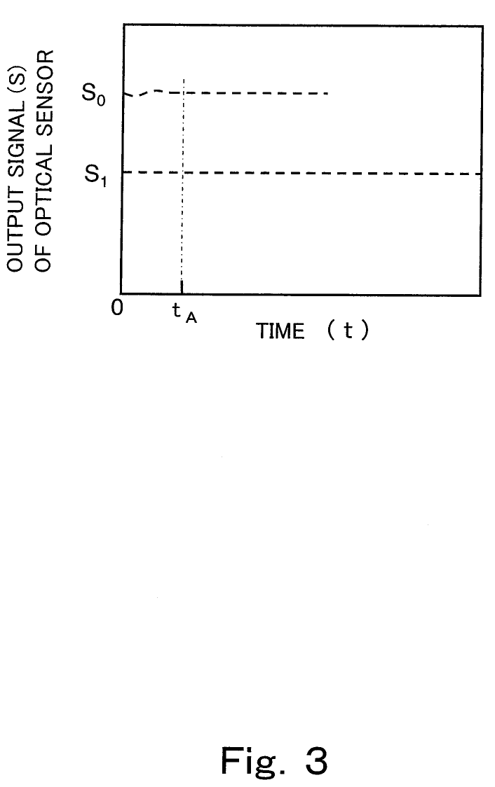

When the laser light 107 travels across the liquid level 102 of the test solution, it is reflected and refracted at the liquid level 102. Therefore, the amount of the transmitted light which reaches the optical sensor 108 decreases. Here, the time change of the output signal S of the optical sensor 108 will be explained in reference to FIGS. 3 to 5.

FIGS. 3, 4, and 5 are schematic diagrams showing the time change of the output signal S from the optical sensor 108 of the optical measuring device 100. In FIGS. 3 to 5, a horizontal axis denotes an elapsed time since the start of the measurement of the transmitted light, i.e., from the input of the stirring start instruction, and a vertical axis denotes the output signal S of the optical sensor 108. When the time t is 0 at the start of the stirring, the distance d from the lowermost portion of the liquid level 102 of the test solution to the bottom surface of the sample cell 101 is 6 mm, and the output signal S of the optical sensor 108 is S₀.

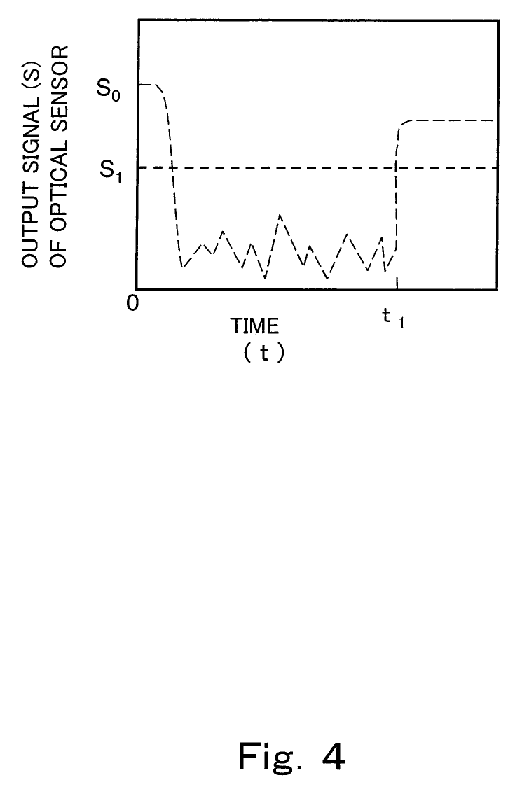

As shown in FIG. 4, the output signal S from the optical sensor 108 becomes smaller than the threshold S₁ of the output signal S. The memory (not shown) incorporated in the computer 109 stores the threshold S₁ of the output signal S from the optical sensor 108. By detecting that the output signal S from the optical sensor 108 has become smaller than the threshold S₁ stored in the memory, the computer 109 can detect that the magnetic rotor 103 has started the rotational movement.

However, as shown in FIG. 3, when the output signal S from the optical sensor 108 does not become smaller than the threshold S₁ even after the time t_{A} has passed from the input of the stirring start instruction, the computer 109 can detect that the magnetic rotor 103 does not follow the rotational movement of the magnet 202 but continues to stop.

Then, the computer 109 which has detected that the magnetic rotor 103 continues to stop causes the driving unit 104 to stop operating once and outputs an error signal to the display portion 105. The display portion 105 which has received the error signal displays the error information.

Then, the computer 109 causes the driving unit 104 to drive again to rotate the magnet 202. The drive control of the driving unit 104 by the computer 109 after the start of driving of the driving unit 104 is the same as the above-described initial drive control.

In the initial drive control of the driving unit 104 by the computer 109, the number of rotations is gradually increased so as to reach a specified number of rotations in 3 seconds. However, the time taken to reach a specified number of rotations may be increased to 4 seconds for example or may be decreased to 2.5 seconds, thereby prompting the magnetic rotor 103 to rotate, which does not follow the rotational movement of the magnet 202 and is not rotated in the initial drive control.

Moreover, the driving unit 104 and the magnet 202 may be rotated in a direction opposite to the rotational direction in the initial drive control of the driving unit 104 by the computer 109, thereby prompting the magnetic rotor 103 to rotate, which does not follow the rotational movement of the magnet 202 and is not rotated in the initial drive control.

Further, a second drive control of the driving unit 104 by the computer 109 is totally the same as the initial drive control. To be specific, when the computer 109 has detected in the second drive control that the magnetic rotor 103 does not follow the rotational movement of the magnet 202 and continues to stop, the time necessary for the magnet 202 to reach a specified number of rotations may be changed in a third drive control of the driving unit 104 by the computer 109, or the rotational direction of the magnet 202 is changed in the third drive control, thereby prompting the magnetic rotor 103 to rotate.

FIG. 4 shows changes of the output signal S in a case where the magnetic rotor 103 stops rotating since the magnetic rotor 103 cannot follow the rotational movement of the magnet 202, attached to the rotating shaft 200 of the driving unit 104, at a time at which a time t₁ that is shorter than the predetermined time t₀ has passed from the start of the measurement of the transmitted light, i.e., from the input of the stirring start instruction.

The time t₁ is shorter than the predetermined time t₀. In a state in which the time t₁ has passed from the input of the stirring start instruction, it is determined that the stirring of the test solution is not completed.

When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. Thus, the distance d from the lowermost portion of the liquid level 102 of the test solution containing the sample solution and the reagent to the bottom surface of the sample cell 101 becomes long such that the distance from the optical axis of the laser light 107 to the lowermost portion of the liquid level 102 of the test solution becomes four times as long as the beam radius. In this case, the laser light 107 corresponding to the light power of about 99.97% of the total power travels in the test solution, and the output signal S from the optical sensor 108 which receives the laser light 107 emitted from the semiconductor laser module 106 is increased to the threshold S₁ or more.

Therefore, by detecting that the output signal S from the optical sensor 108 has reached the threshold S₁ stored in the memory after the computer 109 has detected that the magnetic rotor 103 has started the rotational movement, the computer 109 can detect that the magnetic rotor 103 has stopped rotating.

When the computer 109 detects that the magnetic rotor 103 has stopped rotating, it outputs the error signal to the display portion 105. The display portion 105 which has received the error signal displays the error information. Moreover, when the computer 109 detects that the magnetic rotor 103 has stopped rotating, it causes the driving unit 104 to stop operating. Thus, the rotational movement of the magnet 202 attached to the rotating shaft 200 of the driving unit 104 automatically stops. Moreover, when the computer 109 detects that the magnetic rotor 103 has stopped rotating, it causes the semiconductor laser module 106 to stop operating. Thus, the measurement of the transmitted light by the computer 109 automatically stops.

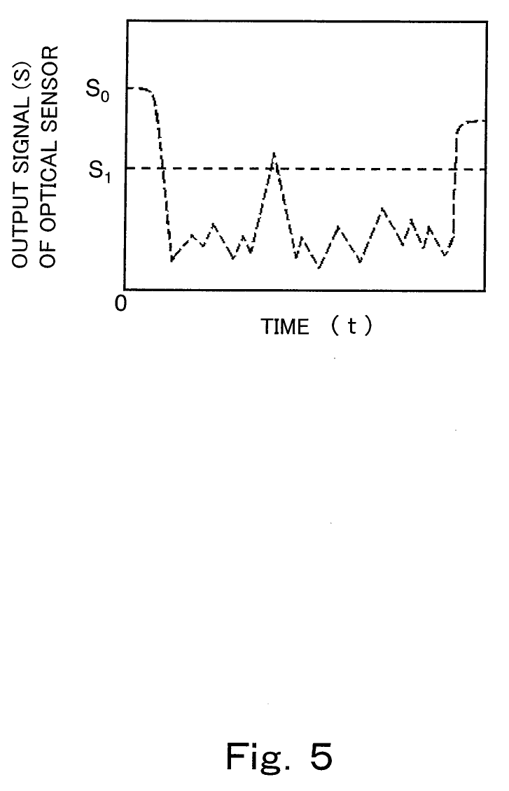

The shape of the test solution 102 depressed in a bowl shape formed by the rotational movement of the magnetic rotor 103 is not always fixed but is changing. Therefore, the output signal S from the optical sensor 108 fluctuates, and the output signal S from the optical sensor 108 may be temporarily increased to the threshold S₁ or more as shown in FIG. 5 even if the magnetic rotor 103 continues the rotational movement.

When the computer 109 determines that the magnetic rotor 103 has stopped rotating based on the fact that the output signal S from the optical sensor 108 has been temporarily increased to the threshold S₁ or more, the computer 109 causes the driving unit 104 to stop operating even though the magnetic rotor 103 continues the rotational movement. As a result, the stirring operation terminates even though the stirring of the test solution is not completed.

In order to prevent the computer 109 from making erroneous determinations and carrying out erroneous control, included as a condition for allowing the computer 109 to determine that the magnetic rotor 103 has stopped rotating is that the output signal S continues to be the threshold S₁ or more for a certain time, for example, 0.5 second. Thus, when the output signal S has been temporarily (less than 0.5 second in this case) increased to the threshold S₁ or more, the computer 109 does not determine that the magnetic rotor 103 has stopped rotating.

On the other hand, when the computer 109 does not detect, until the time t₀ passes, that the magnetic rotor 103 has stopped rotating, the computer 109 causes the driving unit 104 to stop operating to automatically terminate the stirring of the test solution. Since the rotational movement of the magnet 202 attached to the rotating shaft 200 of the driving unit 104 automatically stops, the magnetic rotor 103 stops rotating.

When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. Thus, the distance d from the lowermost portion of the liquid level 102 of the test solution containing the sample solution and the reagent to the bottom surface of the sample cell 101 becomes long such that the distance from the optical axis of the laser light 107 to the lowermost portion of the liquid level 102 of the test solution becomes four times as long as the beam radius. In this case, the laser light 107 corresponding to the light power of about 99.97% of the total power travels in the test solution, and the output signal S from the optical sensor 108 which receives the laser light 107 emitted from the semiconductor laser module 106 is increased to the threshold S₁ or more.

By detecting that the output signal S from the optical sensor 108 has reached the threshold S₁, the computer 109 can detect that the magnetic rotor 103 has surely stopped rotating. After detecting that the output signal S from the optical sensor 108 has reached the threshold S₁, the computer 109 analyzes the output signal S of the optical sensor 108 to measure the concentration of a specific component in the test solution.

As explained above, in accordance with the stirring state detecting method according to the present embodiment, since it is unnecessary to use the magnetic sensor to detect the rotation state of the magnetic rotor 103 itself, it is possible to accurately detect, without being affected by the ambient surroundings, that the magnetic rotor 103 disposed inside the sample cell 101 has stopped rotating.

The present embodiment has explained an example in which the laser light 107 emitted from the semiconductor laser module 106 is incident on the optical window 204 of the sample cell 101 in the vertical direction. However, the present embodiment is not limited to this. The semiconductor laser module 106 and the optical sensor 108 may be disposed such that the transmitted light having been refracted at the optical windows 204 and 206 and emitted from the optical window 206 reaches the optical sensor 108 even if the laser light 107 is incident on the optical window 204 of the sample cell 101 at an angle other than a right angle.

### EMBODIMENT 2

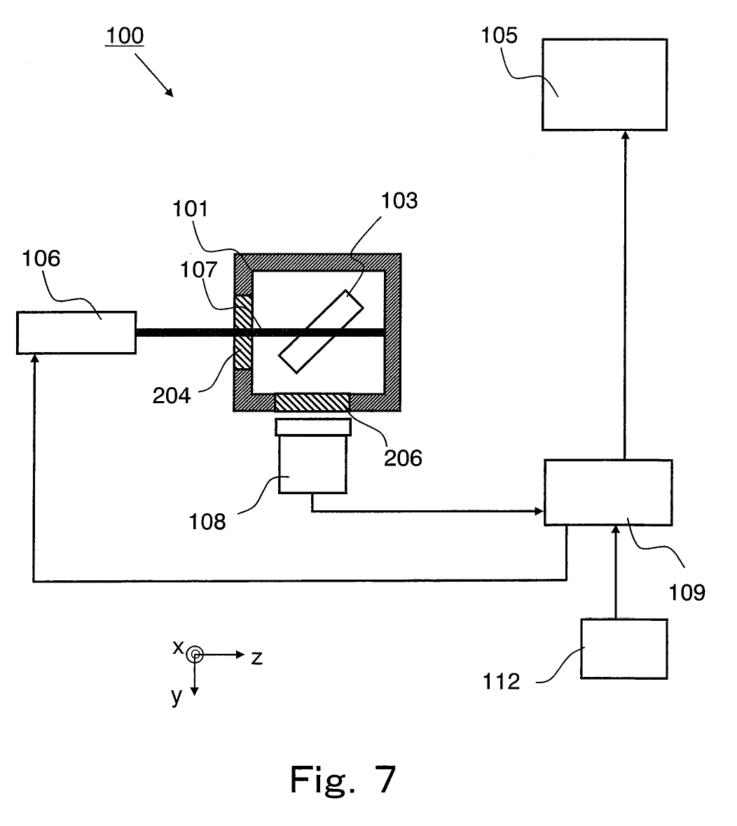

Next, the stirring state detecting method according to Embodiment 2 of the present invention will be explained in reference to FIG. 7. FIG. 7 is a top view showing a schematic configuration of the optical measuring device used in the stirring state detecting method according to Embodiment 2.

As shown in FIG. 7, the optical measuring device 100 used in the stirring state detecting method according to Embodiment 2 of the present invention is different from the optical measuring device 100 of Embodiment 1 in that: the semiconductor laser module 106 and the optical sensor 108 are disposed such that the optical axis of the laser light 107 emitted from the semiconductor laser module 106 and a normal line with respect to a light receiving surface of the optical sensor 108 intersect with each other at a right angle; and accordingly, two optical windows 204 and 206 of the sample cell 101 are disposed on two adjacent side surfaces of four side surfaces surrounding the sample cell 101. The other components of Embodiment 2 are the same as those of Embodiment 1, so that explanations thereof are omitted.

In the optical measuring device 100, the optical sensor 108 receives scattered light which has been generated in the test solution in the sample cell 101 by the irradiation of the laser light 107 and emitted from the optical window 206, and outputs the output signal S corresponding to the amount of the light received. The computer 109 analyzes the output signal S from the optical sensor 108 to determine whether or not the magnetic rotor 103 is normally rotated. As a result of the analysis, when the computer 109 determines that the magnetic rotor 103 is not normally rotated, the computer 109 causes the display device 105 to display the error.

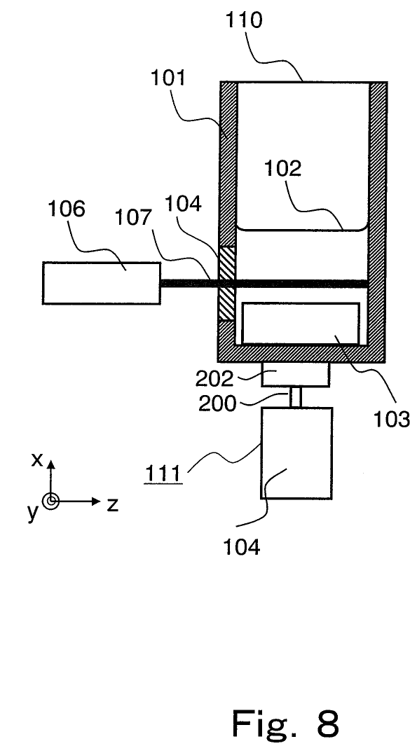

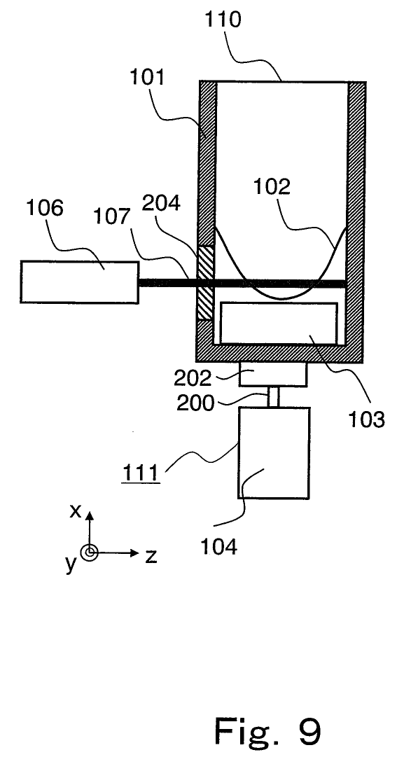

Next, a method for analyzing the output signal S from the optical sensor 108 using the optical measuring device 100 shown in FIG. 7 to determine whether or not the magnetic rotor 103 is normally rotated will be explained in reference to FIGS. 7 to 9. FIG. 8 is a schematic diagram showing a partial schematic configuration in a state in which the test solution is supplied in the sample cell 101 of the optical measuring device 100 shown in FIG. 7. FIG. 9 is a schematic diagram showing a partial schematic configuration in a state in which the magnetic rotor 103 disposed inside the sample cell 101 of the optical measuring device 100 shown in FIG. 7 is rotated.

Since the laser light 107 emitted from the semiconductor laser module 106 is the Gaussian beam as with Embodiment 1, the light power density of the laser light 107 is the highest on the optical axis in the cross section perpendicular to the traveling direction. The power density of the laser light 107 at a position in the beam cross section decreases in accordance with Formula (1) above as the position is farther away from the optical axis.

As shown in FIG. 8, the test solution is supplied in the sample cell 101 such that the distance from the optical axis of the laser light 107 to the lowermost portion of the liquid level 102 of the test solution becomes four times as long as the beam radius, i.e., the distance d from the lowermost portion of the liquid level 102 to the bottom surface of the sample cell 101 becomes 6 mm. At this time, the laser light 107 corresponding to the light power of about 99.97% of the total power travels in the test solution.

Next, when the magnetic rotor driving unit 104 is driven to cause the magnetic rotor 103 to rotate, the liquid level 102 of the test solution is depressed in a bowl shape, and the position of the lowermost portion of the liquid level 102 lowers. As with Embodiment 1, as shown in FIG. 9, the magnetic rotor 103 is rotated such that the lowermost portion of the liquid level 102 of the test solution is lower than a position which is lower than the optical axis of the laser light 107 by a distance of the beam radius, i.e., the distance d is shorter than 3.5 mm. At this time, the laser light 107 corresponding to the light power of more than about 86.5% of the total power travels across the liquid level 102 of the test solution. When the laser light 107 travels across the liquid level 102 of the test solution, the laser light 107 is reflected and refracted at the liquid level 102 to scatter. Therefore, laterally scattered light generated in the test solution in the sample cell 101 decreases. Thus, the scattered light which reaches the optical sensor 108 decreases, and thereby the output signal S from the optical sensor 108 decreases.

When the magnetic rotor 103 cannot follow the rotational movement of the magnet 202, which is attached to the rotating shaft 200 of the driving unit 104, while the magnetic rotor driving unit 104 is driving, and the magnetic rotor 103 is rotating, the magnetic rotor 103 stops rotating. When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. With this, the output signal S from the optical sensor 108 increases.

Therefore, by detecting that the output signal S from the optical sensor 108 has been once decreased by the rotation of the magnetic rotor 103 in conjunction with the start of the operation of the magnetic rotor driving unit 104 and again increased, it is possible to detect that the magnetic rotor 103 has stopped rotating.

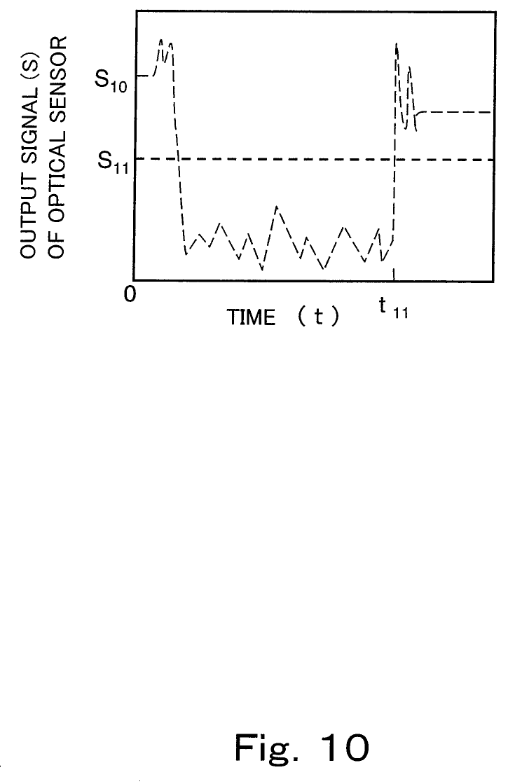

Next, operations of the optical measuring device 100 shown in FIG. 7 will be explained in reference to FIG. 10. FIG. 10 is a diagram showing the time change of the output signal S from the optical sensor 108 of the optical measuring device 100 shown in FIG. 7.

First, the user supplies the sample solution in the sample cell 101 through the opening 110 formed at the upper portion of the sample cell 101. Next, the user supplies the reagent in the sample cell 101 through the opening 110. Thus, the test solution containing the sample solution and the reagent is prepared in the sample cell 101. At this time, the user supplies the sample solution and the reagent in the sample cell 101 such that the distance d from the lowermost portion of the liquid level 102 of the test solution to the bottom surface of the sample cell 101 becomes 6 mm. The method for supplying a predetermined amount of sample solution is the same as the method in Embodiment 1, so that an explanation thereof is omitted.

Next, the user inputs the stirring start instruction from the input device 112. When the computer 109 receives the stirring start instruction from the input device 112, the computer 109 causes the semiconductor laser module 106 to drive. In response to the signal from the computer 109, the semiconductor laser module 106 projects the laser light 107 to the optical window 204 of the sample cell 101. The computer 109 causes the semiconductor laser module 106 to drive, and at the same time, the computer 109 receives from the optical sensor 108 the output signal corresponding to the amount of the light received, thereby starting measuring the scattered light which has been generated in the test solution in the sample cell 101 to be emitted from the optical window 206.

FIG. 10 shows the time change of the output signal S of the optical sensor 108. In FIG. 10, a horizontal axis denotes an elapsed time since the start of the measurement of the scattered light, i.e., from the input of the stirring start instruction, and a vertical axis denotes the output signal S of the optical sensor 108. When the time t is 0 at the start of the stirring, the distance d from the lowermost portion of the liquid level 102 of the test solution to the bottom surface of the sample cell 101 is 6 mm, and the output signal S of the optical sensor 108 is S₁₀.

Moreover, the computer 109 causes the semiconductor laser module 106 to drive, and at the same time, the computer 109 causes the magnetic rotor driving unit 104 to drive. In response to the signal from the computer 109, the magnet 202 attached to the rotating shaft 200 of the driving unit 104 is rotated. The magnetic rotor 103 disposed inside the sample cell 101 starts the rotational movement in sync with the rotation of the magnet 202 of the driving unit 104. The magnetic rotor driving unit 104 is controlled by the computer 109 so as to continue to drive for a predetermined time (t₀).

When the magnetic rotor 103 starts the rotational movement to stir the test solution held in the sample cell 101, the liquid level 102 of the test solution is depressed in a bowl shape, and the position of the lowermost portion of the liquid level 102 lowers. At this time, the number of rotations of the magnet 202 is controlled such that the lowermost portion of the liquid level 102 of the test solution is lower than a position which is lower than the optical axis of the laser light 107 by a distance of the beam radius, i.e., the distance d is shorter than 3.5 mm. The number of rotations of the magnet 202 is controlled in the same manner as in Embodiment 1.

When the laser light 107 travels across the liquid level 102 of the test solution, the laser light 107 is reflected and refracted at the liquid level 102. Therefore, the laterally scattered light generated in the test solution in the sample cell 101 decreases. On this account, the amount of the scattered light which reaches the optical sensor 108 decreases. Thus, as shown in FIG. 10, the output signal S from the optical sensor 108 becomes smaller than a threshold S₁₁ of the output signal S. The memory (not shown) incorporated in the computer 109 stores the threshold S₁₁ of the output signal S from the optical sensor 108. By detecting that the output signal S from the optical sensor 407 has become smaller than the threshold S₁₁ stored in the memory, the computer 109 can detect that the magnetic rotor 103 has started the rotational movement.

FIG. 10 shows an assumption in which the magnetic rotor 103 cannot follow the rotational movement of the magnet 202 attached to the rotating shaft 200 of the magnetic rotor driving unit 104 at a time at which the time t₁₁ has passed from the start of the measurement of the scattered light, i.e., from the input of the stirring start instruction, and thereby the magnetic rotor 103 stops rotating. When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. Thus, the output signal S from the optical sensor 108 is increased to the threshold S₁₁ or more. Therefore, by detecting that the output signal S from the optical sensor 108 has reached the threshold S₁₁ stored in the memory after the computer 109 has detected that the magnetic rotor 103 has started the rotational movement, the computer 109 can detect that the magnetic rotor 103 has stopped rotating.

When the computer 109 detects that the magnetic rotor 103 has stopped rotating, it outputs the error signal to the display device 105. The display device 105 which has received the error signal displays the error information. Moreover, when the computer 109 detects that the magnetic rotor 103 has stopped rotating, it causes the magnetic rotor driving unit 104 to stop operating. Thus, the rotational movement of the magnet 202 attached to the rotating shaft 200 of the magnetic rotor driving unit 104 automatically stops. Moreover, when the computer 109 detects that the magnetic rotor 103 has stopped rotating, it causes the semiconductor laser module 106 to stop operating. Thus, the measurement of the scattered light by the computer 109 automatically stops.

Meanwhile, when the computer 109 does not detect, until the time t₀ passes, that the magnetic rotor 103 has stopped rotating, the computer 109 causes the magnetic rotor driving unit 104 to stop operating to automatically terminate the stirring of the test solution. Since the rotational movement of the magnet 202 attached to the rotating shaft 200 of the magnetic rotor driving unit 104 automatically stops, the magnetic rotor 103 stops rotating.

By detecting that the output signal S from the optical sensor 108 has reached the threshold S₁₁, the computer 109 can detect that the magnetic rotor 103 has surely stopped rotating. After detecting that the output signal S from the optical sensor 108 has reached the threshold S₁₁, the computer 109 analyzes the output signal S of the optical sensor 108 to measure the concentration of the specific component in the test solution.

As explained above, in accordance with the stirring state detecting method according to the present embodiment, since it is unnecessary to use the magnetic sensor to detect the rotation state of the magnetic rotor 103 itself, it is possible to accurately detect, without being affected by the ambient surroundings, that the magnetic rotor 103 disposed inside the sample cell 101 has stopped rotating.

The present embodiment has explained an example in which the laser light 107 emitted from the semiconductor laser module 106 is incident on the optical window 204 of the sample cell 101 in the vertical direction. However, the present embodiment is not limited to this. The semiconductor laser module 106 and the optical sensor 108 may be disposed such that the scattered light having been refracted at the optical windows 204 and 206 and emitted from the optical window 206 reaches the optical sensor 108 even if the laser light 107 is incident on the optical window 204 of the sample cell 101 at an angle other than a right angle.

### EMBODIMENT 3

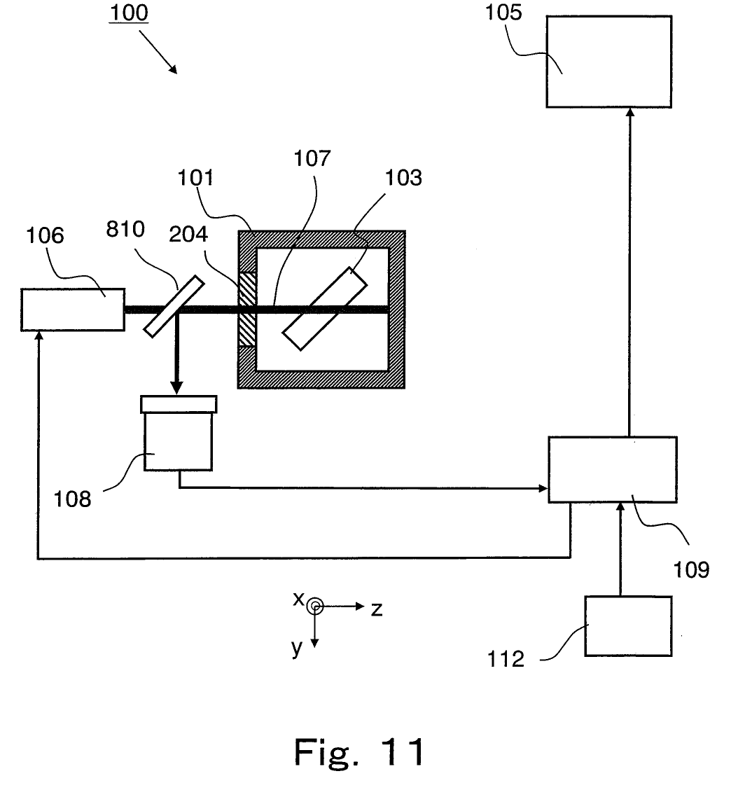

Next, the stirring state detecting method according to Embodiment 3 of the present invention will be explained in reference to FIG. 11. FIG. 11 is a top view showing a schematic configuration of the optical measuring device used in the stirring state detecting method according to Embodiment 3.

The optical measuring device 100 shown in FIG. 11 is different from the optical measuring device 100 of Embodiment 1 in that a beam splitter 810 is included between the light source 106 and the sample cell 101. In addition, the optical measuring device 100 shown in FIG. 11 is different from the optical measuring device 100 of Embodiment 1 in that: the optical sensor 108 which receives backscattered light emitted from the sample cell 101 is included instead of the optical sensor 108 which receives the transmitted light; and only one optical window 204 is included. The other components are the same as those of Embodiment 1, so that explanations thereof are omitted.

In the optical measuring device 100, the optical sensor 108 receives the backscattered light which has been generated in the test solution in the sample cell 101 by the irradiation of the laser light 107, emitted from the optical window 204, and reflected by the beam splitter 810, and outputs the output signal S corresponding to the amount of the light received. The computer 109 analyzes the output signal S from the optical sensor 108 to determine whether or not the magnetic rotor 103 is normally rotated. As a result of the analysis, when the computer 109 determines that the magnetic rotor 103 is not normally rotated, it causes the display device 105 to display the error.

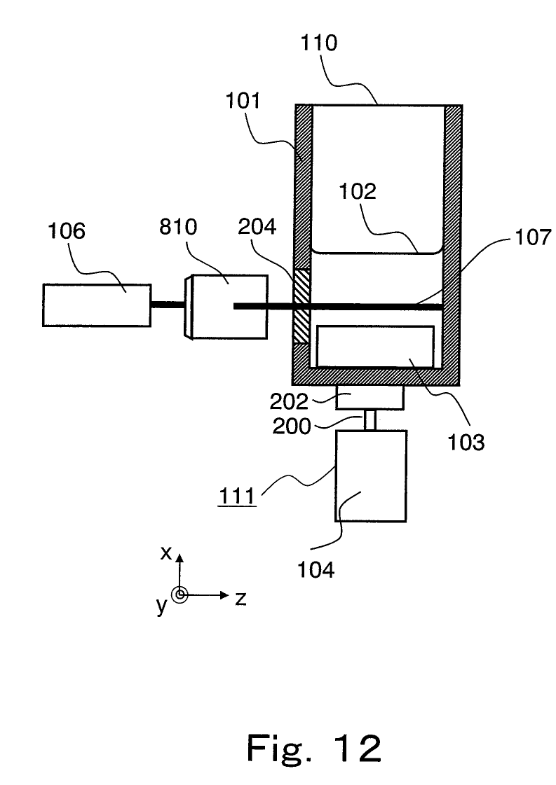

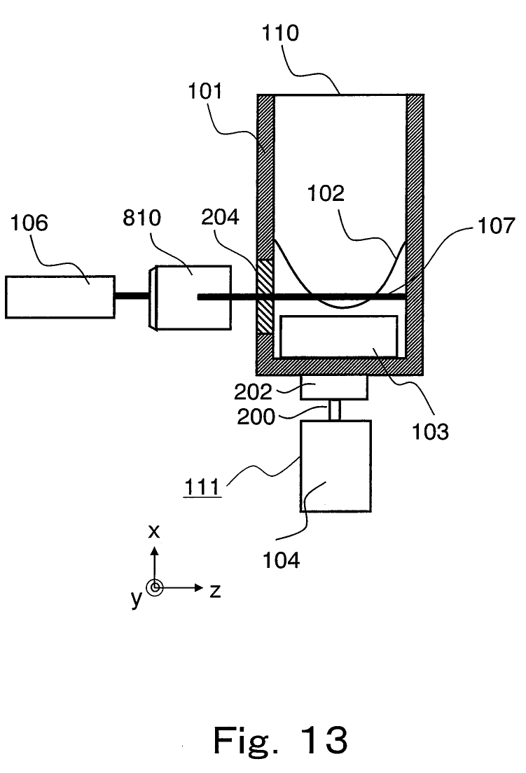

Next, a method for analyzing the output signal S from the optical sensor 108 using the optical measuring device 100 shown in FIG. 11 to determine whether or not the magnetic rotor 103 is normally rotated will be explained in reference to FIGS. 11 to 13. FIG. 12 is a schematic diagram showing a partial schematic configuration in a state in which the test solution is supplied in the sample cell 101 of the optical measuring device 100 shown in FIG. 11. FIG. 13 is a schematic diagram showing a partial schematic configuration in a state in which the magnetic rotor 103 disposed inside the sample cell 101 of the optical measuring device 100 shown in FIG. 11 is rotated.

Since the laser light 107 emitted from the semiconductor laser module 106 is the Gaussian beam as with Embodiment 1, the light power density of the laser light 107 is the highest on the optical axis in the cross section perpendicular to the traveling direction. The power density of the laser light 107 at a position in the beam cross section decreases in accordance with Formula (1) above as the position is farther away from the optical axis.

As shown in FIG. 12, the test solution is supplied in the sample cell 101 such that the distance from the optical axis of the laser light 107 to the lowermost portion of the liquid level 102 of the test solution becomes four times as long as the beam radius, i.e., the distance d from the lowermost portion of the liquid level 102 to the bottom surface of the sample cell 101 becomes 6 mm. At this time, the laser light 107 corresponding to the light power of about 99.97% of the total power travels in the test solution.

Next, when the magnetic rotor driving unit 104 is driven to cause the magnetic rotor 103 to rotate, the liquid level 102 of the test solution is depressed in a bowl shape, and the position of the lowermost portion of the liquid level 102 lowers. As with Embodiment 1, as shown in FIG. 13, the magnetic rotor 103 is rotated such that the lowermost portion of the liquid level 102 of the test solution is lower than a position which is lower than the optical axis of the laser light 107 by a distance of the beam radius, i.e., the distance d is shorter than 3.5 mm. At this time, the laser light 107 corresponding to the light power of more than about 86.5% of the total power travels across the liquid level 102 of the test solution. When the laser light 107 travels across the liquid level 102 of the test solution, the laser light 107 is reflected and refracted at the liquid level 102 to scatter. Therefore, the backscattered light generated in the sample cell 101 increases. Thus, the backscattered light which reaches the optical sensor 108 increases, and thereby the output signal S from the optical sensor 108 increases.

When the magnetic rotor 103 cannot follow the rotational movement of the magnet 202, which is attached to the rotating shaft 200 of the driving unit 104, while the magnetic rotor driving unit 104 is driving, and the magnetic rotor 103 is rotating, the magnetic rotor 103 stops rotating. When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. With this, the output signal S from the optical sensor 108 decreases.

Therefore, by detecting that the output signal S from the optical sensor 108 has been once increased by the rotation of the magnetic rotor 103 in conjunction with the start of the operation of the magnetic rotor driving unit 104 and again decreased, it is possible to detect that the magnetic rotor 103 has stopped rotating.

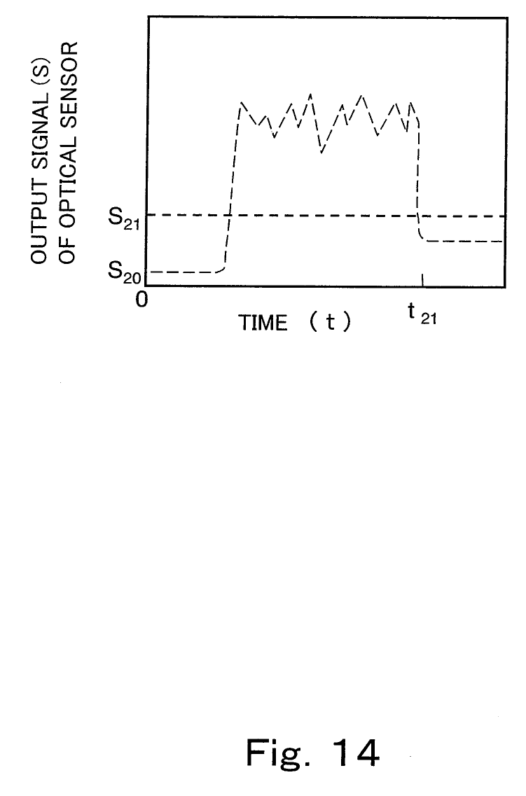

Next, operations of the optical measuring device 100 shown in FIG. 11 will be explained in reference to FIG. 14. FIG. 14 is a schematic diagram showing the time change of the output signal S from the optical sensor 108 of the optical measuring device 100 shown in FIG. 11.

First, the user supplies the sample solution in the sample cell 101 through the opening 110 formed at the upper portion of the sample cell 101. Next, the user supplies the reagent in the sample cell 101 through the opening 110. Thus, the test solution containing the sample solution and the reagent is prepared in the sample cell 101. At this time, the user supplies the sample solution and the reagent in the sample cell 101 such that the distance d from the lowermost portion of the liquid level 102 of the test solution to the bottom surface of the sample cell 101 becomes 6 mm. The method for supplying a predetermined amount of sample solution is the same as the method in Embodiment 1, so that an explanation thereof is omitted.

Next, the user inputs the stirring start instruction from the input device 112. When the computer 109 receives the stirring start instruction from the input device 112, the computer 109 causes the semiconductor laser module 106 to drive. In response to the signal from the computer 109, the semiconductor laser module 106 projects the laser light 107 to the optical window 204 of the sample cell 101. The computer 109 causes the semiconductor laser module 106 to drive, and at the same time, the computer 109 receives from the optical sensor 108 the output signal corresponding to the amount of the light received, thereby starting measuring the backscattered light which has been generated in the sample cell 101 to be emitted from the optical window 204.

FIG. 14 shows the time change of the output signal S of the optical sensor 108. In FIG. 14, a horizontal axis denotes an elapsed time since the start of the measurement of the backscattered light, i.e., from the input of the stirring start instruction, and a vertical axis denotes the output signal S of the optical sensor 108. When the time t is 0 at the start of the stirring, the distance d from the lowermost portion of the liquid level 102 of the test solution to the bottom surface of the sample cell 101 is 6 mm, and the output signal S of the optical sensor 108 is S₂₀.

Moreover, the computer 109 causes the semiconductor laser module 106 to drive, and at the same time, the computer 109 causes the magnetic rotor driving unit 104 to drive. In response to the signal from the computer 109, the magnet 202 attached to the rotating shaft 200 of the magnetic rotor driving unit 104 is rotated. The magnetic rotor 103 disposed inside the sample cell 101 starts the rotational movement in sync with the rotation of the magnet 202 of the driving unit 104. The magnetic rotor driving unit 104 is controlled by the computer 109 so as to continue to drive for a predetermined time (t₀).

When the magnetic rotor 103 starts the rotational movement to stir the test solution held in the sample cell 101, the liquid level 102 of the test solution is depressed in a bowl shape, and the position of the lowermost portion of the liquid level 102 lowers. At this time, the number of rotations of the magnet 202 is controlled such that the lowermost portion of the liquid level 102 of the test solution is lower than a position which is lower than the optical axis of the laser light 107 by a distance of the beam radius, i.e., the distance d is shorter than 3.5 mm. The number of rotations of the magnet 202 is controlled in the same manner as in Embodiment 1.

When the laser light 107 travels across the liquid level 102 of the test solution, the laser light 107 is reflected and refracted at the liquid level 102. Therefore, the backscattered light generated in the sample cell 101 increases. On this account, the amount of the backscattered light which reaches the optical sensor 108 increases. Thus, as shown in FIG. 14, the output signal S from the optical sensor 108 becomes larger than a threshold S₂₁ of the output signal S. The memory (not shown) incorporated in the computer 109 stores the threshold S₂₁ of the output signal S from the optical sensor 108. By detecting that the output signal S from the optical sensor 108 has become larger than the threshold S₂₁ stored in the memory, the computer 109 can detect that the magnetic rotor 103 has started the rotational movement.

FIG. 14 shows an assumption in which the magnetic rotor 103 cannot follow the rotational movement of the magnet 202 attached to the rotating shaft 200 of the magnetic rotor driving unit 104 at a time at which the time t₂₁ has passed from the start of the measurement of the backscattered light, i.e., from the input of the stirring start instruction, and thereby the magnetic rotor 103 stops rotating. When the magnetic rotor 103 stops rotating, the bowl-shape depressed liquid level 102 of the test solution moves up to a position before the rotation of the magnetic rotor 103, i.e., the bowl-shape depressed liquid level 102 of the test solution moves up to such a position that the distance d becomes 6 mm. Thus, the output signal S from the optical sensor 108 is decreased to the threshold S₂₁ or less. Therefore, by detecting that the output signal S from the optical sensor 108 has reached the threshold S₂₁ stored in the memory after the computer 109 has detected that the magnetic rotor 103 has started the rotational movement, the computer 109 can detect that the magnetic rotor 103 has stopped rotating.

When the computer 109 detects that the magnetic rotor 103 has stopped rotating, it outputs the error signal to the display device 105. The display device 105 which has received the error signal displays the error information. Moreover, when the computer 109 detects that the magnetic rotor 103 has stopped rotating, it causes the magnetic rotor driving unit 104 to stop operating. Thus, the rotational movement of the magnet 202 attached to the rotating shaft 200 of the magnetic rotor driving unit 104 automatically stops. Moreover, when the computer 109 detects that the magnetic rotor 103 has stopped rotating, it causes the semiconductor laser module 106 to stop operating. Thus, the measurement of the backscattered light by the computer 109 automatically stops.

Meanwhile, when the computer 109 does not detect, until the time t₀ passes, that the magnetic rotor 103 has stopped rotating, the computer 109 causes the magnetic rotor driving unit 104 to stop operating to automatically terminate the stirring of the test solution. Since the rotational movement of the magnet 202 attached to the rotating shaft 200 of the magnetic rotor driving unit 104 automatically stops, the magnetic rotor 103 stops rotating.

By detecting that the output signal S from the optical sensor 108 has reached the threshold S₂₁, the computer 109 can detect that the magnetic rotor 103 has surely stopped rotating. After detecting that the output signal S from the optical sensor 108 has reached the threshold S₂₁, the computer 109 analyzes the output signal S of the optical sensor 108 to measure the concentration of the specific component in the test solution.

As explained above, in accordance with the stirring state detecting method according to the present embodiment, since it is unnecessary to use the magnetic sensor to detect the rotation state of the magnetic rotor 103 itself, it is possible to accurately detect, without being affected by the ambient surroundings, that the magnetic rotor 103 disposed inside the sample cell 101 has stopped rotating.

The present embodiment has explained an example in which the laser light 107 emitted from the semiconductor laser module 106 is incident on the optical window 204 of the sample cell 101 in the vertical direction. However, the present embodiment is not limited to this. The semiconductor laser module 106 and the optical sensor 108 may be disposed such that the backscattered light having been refracted at the optical window 204, incident on the sample cell 101, and emitted from the optical window 204 reaches the optical sensor 108 even if the laser light 107 is incident on the optical window 204 of the sample cell 101 at an angle other than a right angle.

### EMBODIMENT 4

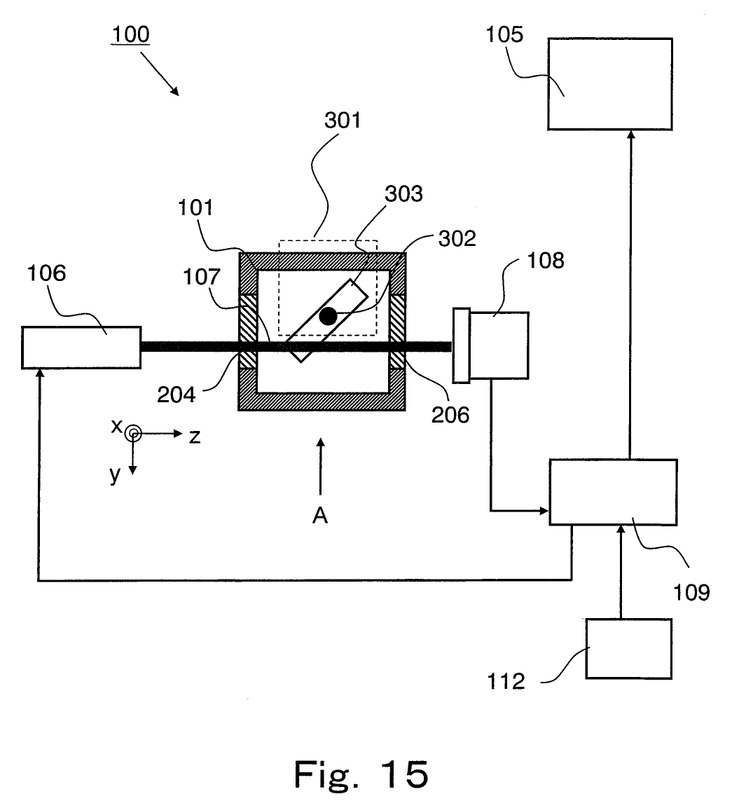

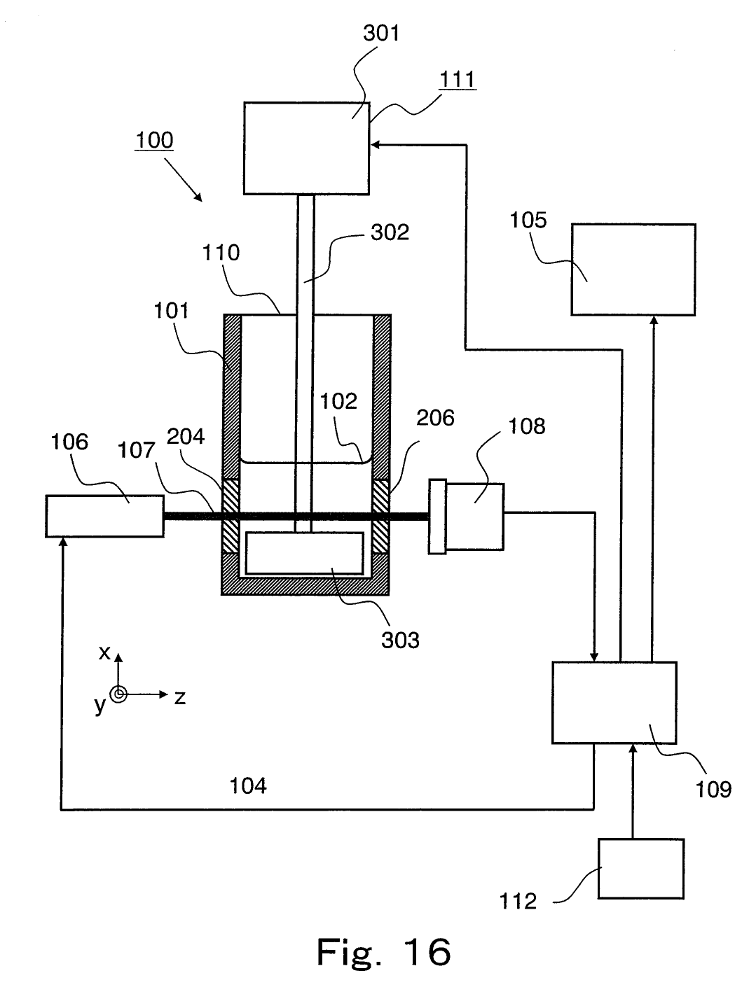

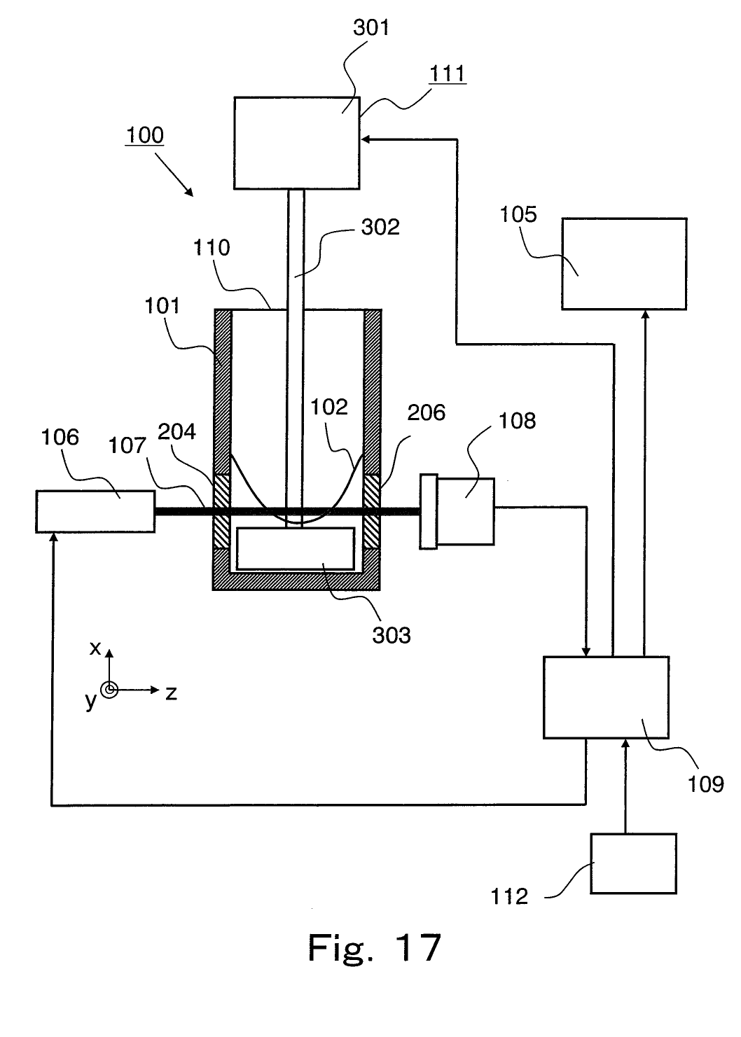

FIG. 15 is a schematic diagram showing a schematic configuration of the optical measuring device used in the stirring state detecting method according to Embodiment 4 of the present invention. FIG. 16 is a schematic diagram of the sample cell of the optical measuring device when viewed in a direction indicated by an arrow A shown in FIG. 15. FIG. 17 is a schematic diagram showing a schematic configuration in a state in which the rotor disposed inside the sample cell of the optical measuring device shown in FIG. 16 is rotated.

As shown in FIGS. 15 to 17, the optical measuring device 100 used in the stirring state detecting method according to Embodiment 4 of the present invention has the same basic configuration as the optical measuring device 100 used in the stirring state detecting method according to Embodiment 1, but is different from the optical measuring device 100 of Embodiment 1 regarding the configuration of the stirring device 111.

Specifically, the stirring device 111 includes a rotating shaft driving unit 301, a rotating shaft 302, and a propeller (rotor) 303. The rotating shaft 302 is disposed to extend in the vertical direction. The propeller 303 is disposed at a tip end of the rotating shaft 302. The rotating shaft driving unit 301 is disposed at a base end of the rotating shaft 302. The rotating shaft driving unit 301 causes the rotating shaft 302 to rotate to cause the propeller 303, disposed at the tip end of the rotating shaft 302, to rotate, thereby stirring the test solution.

The stirring device 111 is disposed such that the propeller 303 is positioned in the vicinity of the bottom surface of the sample cell 101. The semiconductor laser module 106 and the optical sensor 108 are disposed to sandwich the sample cell 101 and to be opposed to each other. Moreover, the semiconductor laser module 106 and the optical sensor 108 are disposed such that the laser light 107 emitted from the semiconductor laser module 106 does not contact the rotating shaft 302 or the propeller 303 of the stirring device 111, and is transmitted through the optical windows 204 and 206.

The same operational advantages as the stirring state detecting method according to Embodiment 1 will be obtained by using the optical measuring device 100 configured as above. In the present embodiment, in order to detect the transmitted light of the laser light 107 emitted from the semiconductor laser module 106, the optical window 204 and the optical window 206 of the sample cell 101 are disposed to be opposed to each other, and the semiconductor laser module 106 and the optical sensor 108 are disposed to sandwich the sample cell 101 and to be opposed to each other. However, the present embodiment is not limited to this. As in Embodiment 2, the scattered light of the laser light 107 may be detected. Moreover, as in Embodiment 3, the reflected light of the laser light 107 may be detected.

### EMBODIMENT 5

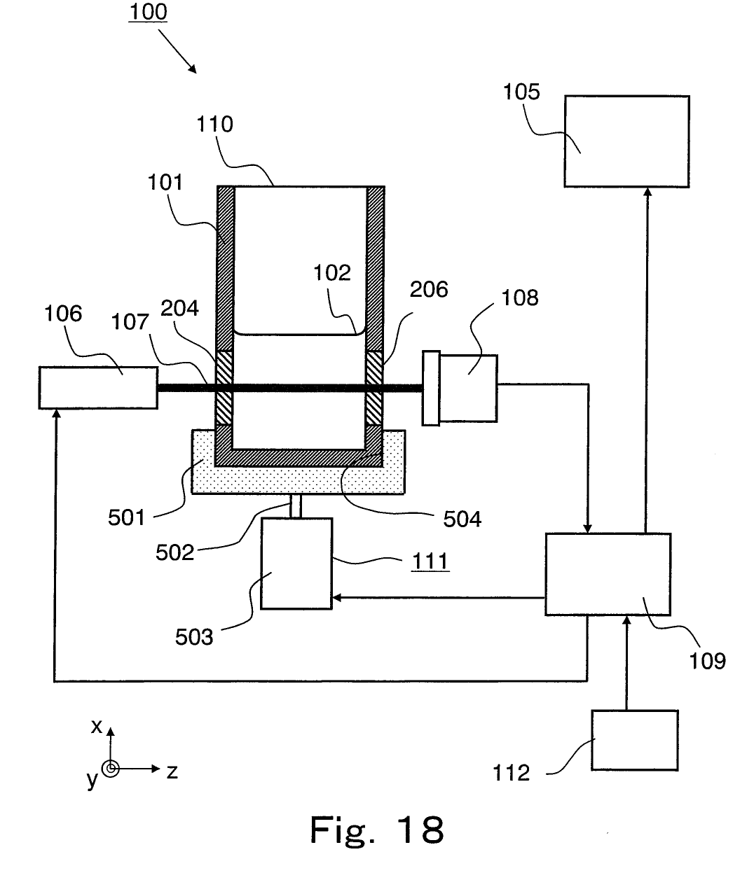

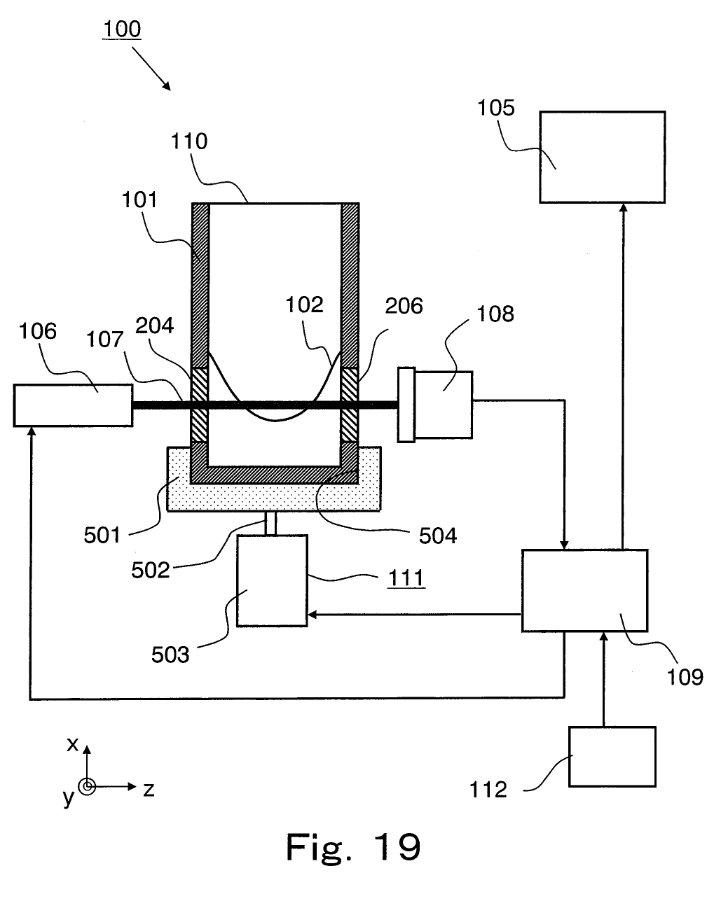

FIG. 18 is a schematic diagram showing a schematic configuration of the optical measuring device used in the stirring state detecting method according to Embodiment 5 of the present invention. FIG. 19 is a schematic diagram showing a schematic configuration in a state in which the sample cell of the optical measuring device shown in FIG. 18 is rotated or turned.

As shown in FIGS. 18 and 19, the optical measuring device 100 used in the stirring state detecting method according to Embodiment 5 of the present invention has the same basic configuration as the optical measuring device 100 used in the stirring state detecting method according to Embodiment 1, but is different from the optical measuring device 100 of Embodiment 1 in that the stirring device 111 causes the sample cell 101 to rotate or turn.

Specifically, the stirring device 111 includes a fitting member 501, a rotating shaft 502, and a drive mechanism 503. The rotating shaft 502 is disposed to extend in the vertical direction. The fitting member 501 is disposed at a tip end of the rotating shaft 502. The drive mechanism 503 which causes the rotating shaft 502 to rotate or turn is disposed at a base end of the rotating shaft 502. Herein, the phrase “causes the rotating shaft 502 to turn” means that an operation for rotating the rotating shaft 502 at a predetermined angle clockwise about a central axis (not shown) of the rotating shaft 502, stopping the rotating shaft 502 once, and rotating the rotating shaft 502 at a predetermined angle counterclockwise is repeated.

A lower end portion of the sample cell 101 fits in an upper portion of the fitting member 501. A fitting hole 504 is formed on the upper portion of the fitting member 501 such that a center of a bottom surface of the sample cell 101 conforms to the central axis (not shown) of the rotating shaft 502. The fitting hole 504 is formed such that even when the drive mechanism 503 causes the sample cell 101 to rotate or turn, the sample cell 101 does not come off from the fitting portion 504.

Moreover, the computer 109 causes the semiconductor laser module 106 to emit the laser light 107 in accordance with the rotational movement or turning movement of the stirring device 111. To be specific, the computer 109 causes the semiconductor laser module 106 to emit the laser light 107 when the optical window 204 of the sample cell 101 is positioned to be opposed to the semiconductor laser module 106. By using, for example, a stepping motor as the drive mechanism 503, it is possible to easily detect a position at which the optical window 204 of the sample cell 101 is opposed to the semiconductor laser module 106.

Thus, the laser light 107 emitted from the semiconductor laser module 106 can be incident on the sample cell 101 from the optical window 204, and the optical sensor 108 can receive the transmitted light (laser light 107) emitted from the optical window 206.

In the present embodiment, in order to detect the transmitted light of the laser light 107 emitted from the semiconductor laser module 106, the optical window 204 and the optical window 206 of the sample cell 101 are formed to be opposed to each other, and the semiconductor laser module 106 and the optical sensor 108 are disposed to sandwich the sample cell 101 and to be opposed to each other. However, the present embodiment is not limited to this. As in Embodiment 2, the scattered light of the laser light 107 may be detected. Moreover, as in Embodiment 3, the reflected light of the laser light 107 may be detected.

The same operational advantage as the stirring state detecting method according to Embodiment 1 can be obtained even by using the optical measuring device 100 configured as above.

In the above embodiments, the test solution is supplied in the sample cell 101 such that the distance from the optical axis of the laser light 107 to the lowermost portion of the liquid level 102 of the test solution containing the sample solution becomes four times as long as the beam radius, i.e., the distance d from the lowermost portion of the liquid level 102 to the bottom surface of the sample cell 101 becomes 6 mm. However, when the distance d is increased or decreased in a certain range, for example, when the distance d is increased or decreased in a range from 5 to 7 mm, the semiconductor laser module 106 and the optical sensor 108 may be caused to move up or down in accordance with the increase or decrease of the distance d.

The increase or decrease of the distance d is determined by graduations (not shown) of the sample cell 101, the mass of the test solution, and the like. Vertical positioning of the semiconductor laser module 106 and the optical sensor 108 is carried out manually or automatically in accordance with the value of the distance d. Since the increase or decrease of the distance d corresponds to the increase or decrease of the amount of the test solution, the predetermined time t₀ at which the stirring of the test solution completes is corrected by the computer 109 so as to be increased or decreased.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

The stirring state detecting method of the present invention is useful when measuring using the sample cell the optical property of the test solution, especially the body fluid.

1. A method for detecting a stirring state of a test solution by using: a sample cell which holds the test solution in an internal space thereof; a stirring device which stirs the test solution held in the sample cell; a light emitting device which emits light to the test solution held in the sample cell; and a photoreceiver which receives the light, the method comprising the steps of:
(A) in a state in which the test solution is held in the sample cell, activating the stirring device to change a liquid level of the test solution by stirring;
(B) emitting the light from the light emitting device to the test solution held in the sample cell;
(C) detecting by the photoreceiver an amount of the light which is emitted to the test solution and subjected to an action of the test solution whose liquid level is changed by the stirring; and
(D) determining the stirring state of the test solution based on the amount of the light detected by the photoreceiver in the step (C), wherein
when the amount of the light detected by the photoreceiver in the step (C) reaches a predetermined threshold in the step (D), it is determined that the test solution is not stirred.

2. The method according to claim 1, wherein the stirring device includes a magnetic rotor having a magnetic body, and a magnetic rotor driving unit which generates a change in a magnetic field which causes the magnetic rotor to rotate.

3. The method according to claim 1, wherein the stirring device includes a rotor, a rotating shaft connected to the rotor, and a rotating shaft driving unit which causes the rotating shaft to rotate.

4. The method according to claim 1, wherein the stirring device includes a drive mechanism which causes the sample cell to rotate or turn.

5. The method according to claim 1, wherein:
the step (B) is carried out before activating the stirring device; and
a step (E) of detecting by the photoreceiver the amount of the light subjected to the action of the test solution and determining based on the detected light whether or not the sample cell is filled with the test solution is then carried out.

6. (canceled)

7. The method according to claim 6, further comprising a step (F) of outputting an alarm by an alarm unit when it is determined that the test solution is not stirred.

8. The method according to claim 6, further comprising a step (G) of causing the stirring device to stop operating when it is determined that the test solution is not stirred.

9. The method according to claim 8, further comprising a step (H) of activating the stirring device again after causing the stirring device to stop operating in the step (G).

10. The method according to any one of claims 1 to 4, further comprising a step (I) of finding an optical property of the test solution based on the amount of the light detected by the photoreceiver after the stirring state of the test solution is determined in the step (D).
